(19) United States
(12) Patent Application Publication
(10) Pub. No.: US 2013/0175302 A1
(43) Pub. Date: Jul. 11, 2013

(54) DISPENSER FOR A CONTAINER

(71) Applicant: Costin Sariu, Calgary (CA)

(72) Inventor: Costin Sariu, Calgary (CA)

(73) Assignee: GLOBOINVENT INC., Calgary, AB (CA)

(21) Appl. No.: 13/823,761

(22) PCT Filed: Feb. 24, 2012
(86) PCT No.: PCT/CA12/00173

§ 371 Date: Mar. 15, 2013

Related U.S. Application Data
(60) Provisional application No. 61/446,922, filed on Feb. 25, 2011.

(51) Int. Cl. B67D 3/00

(52) U.S. Cl. CPC B67D 3/0064
USPC 222/212; 222/512; 222/464.1; 222/214; 251/7

(57) ABSTRACT

The present disclosure is directed at a dispenser for a container. The dispenser includes a base portion couplable to the container. The base portion has a port in it through which fluid exiting the container passes when the base portion is coupled to the container. The base portion also includes an external flexible fluid conduit that is fluidly coupled to the port. The external fluid conduit is located outside of the container when the base portion is coupled to the container. A squeezing element also forms part of the dispenser. The squeezing element is coupled to the base portion and movable between a closed position in which the squeezing element squeezes the external fluid conduit shut to prevent the fluid from flowing through it and an opened position in which the squeezing element is positioned such that the fluid can flow through the external fluid conduit.

### TECHNICAL FIELD

The present disclosure is directed at a dispenser for a container. More particularly, the present disclosure is directed at a dispenser for a container that includes a flexible fluid conduit that can be squeezed shut to prevent fluid from escaping the container.

### BACKGROUND

Millions of bottled beverages are sold annually. Some of these beverages are carbonated, in which case the bottle and the dispenser used to contain the beverage should be designed to address the challenges accompanying storing and dispensing carbonated beverages. Research and development accordingly continues into dispensers designed particularly to be used to dispense carbonated beverages.

### BRIEF DESCRIPTION OF THE DRAWINGS

In the accompanying drawings, which illustrate one or more exemplary embodiments:

FIGS. 1 and 2 depict sectional views of a dispenser, according to one embodiment, that is attached to a container and that is in closed (FIG. 1) and opened (FIG. 2) positions.

FIGS. 3(a) and 3(b) depict sectional and front elevation views of a base portion of the dispenser of FIG. 1, and FIG. 3(c) depicts a sectional view of the base portion taken along line A-A of FIG. 3(b).

FIG. 4 depicts a perspective view of a squeezing element that is included in the dispenser of FIG. 1.

FIGS. 5(a) and 5(b) depict sectional views of the dispenser, according to another embodiment, in which the dispenser is mounted to a conventional bottle cap and in which the dispenser is shown in closed (FIG. 5(a)) and opened (FIG. 5(b)) positions.

FIGS. 6(a) and 6(b) depict exploded and perspective views, respectively, of portions of the dispenser of FIG. 5(a).

FIG. 7 depicts a side elevation view of the dispenser and the container to which the dispenser is attached, according to another embodiment in which the dispenser includes an embodiment of a flavour dispensing unit.

FIG. 8 depicts a sectional view of the embodiment of the flavour dispensing unit included in the dispenser of FIG. 7.

FIGS. 9(a) and 9(b) depict sectional views of the dispenser, according to another embodiment that includes a conduit retaining unit, in closed (FIG. 9(a)) and opened (FIG. 9(b)) positions.

FIGS. 10 and 11 depict sectional views of the dispenser, according to another embodiment that lacks a sealing element, in closed (FIG. 10) and opened (FIG. 11) positions.

FIGS. 12(a) and 12(b) depict sectional and front elevation views of the dispenser, according to another embodiment that lacks a sealing element and in which the dispenser is mounted to a conventional bottle cap.

FIGS. 13 and 14 depict sectional views of the dispenser, according to another embodiment, that is attached to the container and that is in closed (FIG. 13) and opened (FIG. 14) positions.

FIG. 15(a) depicts a perspective view of the base portion of the dispenser of FIG. 13.

FIG. 15(b) depicts a sectional view of the base portion of FIG. 15(a) taken along line B-B.

FIG. 15(c) depicts a side cutaway view of the base portion taken along line A-A of FIG. 15(b).

FIGS. 16(a), 16(b) and 16(c) depict perspective, side elevation, and top plan views of one of the squeezing elements that is included in the dispenser of FIG. 13.

FIG. 17 depicts a side elevation view of the dispenser shown in FIG. 13 attached to the container, in which the dispenser includes another embodiment of the flavour dispensing unit.

FIG. 18 depicts a sectional view of the embodiment of the flavour dispensing unit of FIG. 17.

FIG. 19 depicts a sectional view of the dispenser, according to another embodiment that includes the conduit retaining unit.

### SUMMARY

According to one aspect, there is provided a dispenser for a container. The dispenser includes a base portion couplable to the container, wherein the base portion comprises a port through which fluid exiting the container passes when the base portion is coupled to the container; an external flexible fluid conduit fluidly coupled to the port, wherein the external fluid conduit is located outside of the container when the base portion is coupled to the container; and a squeezing element coupled to the base portion and movable between a closed position in which the squeezing element squeezes the external fluid conduit shut to prevent the fluid from flowing therethrough and an opened position in which the squeezing element is positioned such that the fluid can flow through the external fluid conduit.

The squeezing element may be slidable on the base portion between the opened and closed positions.

The dispenser may also include a tension band wrapped along the base portion and the squeezing element to bias the squeezing element in the closed position.

The base can include a shoulder located adjacent one half of the external fluid conduit and the squeezing element can include a projection located adjacent the other half of the external fluid conduit. The projection can squeeze the external fluid conduit against the shoulder when the squeezing element is in the closed position.

The shoulder can have a recess that is aligned with the projection and into which the external fluid conduit is pushed when the squeezing element is in the closed position.

The squeezing element can include an exit path terminating at a dispenser opening located along an outer surface of the dispenser and the external fluid conduit can extend along the exit path and terminate at the dispenser opening to allow the fluid to exit via the dispenser opening when the squeezing element is in the opened position.

According to another aspect, there is provided a dispenser for a container that includes a base portion couplable to the container that comprises a port through which fluid exiting the container passes when the base portion is coupled to the container; an external flexible fluid conduit fluidly coupled to the port that is located outside of the container when the base portion is coupled to the container; and at least two squeezing elements pivotally coupled to the base portion and movable between a closed position in which the squeezing elements collectively squeeze the external fluid conduit shut to prevent the fluid from flowing therethrough and an opened position in which the squeezing elements are positioned such that the fluid can flow through the external fluid conduit.

Each of the squeezing elements may include a fulcrum and a projection and the base portion may include a pair of ledges each supporting one of the fulcrums. The squeezing elements may pivot on the fulcrums as they transition between the closed and opened positions and the projections may collectively squeeze the external fluid conduit when the squeezing elements are in the closed position.

The dispenser may also include a tension band wrapped around the base portion and the squeezing elements to bias the squeezing elements to the closed position.

The fulcrums may be located midway along the squeezing elements and the projections may be located nearer to the container than the fulcrums.

The dispenser may include an internal fluid conduit fluidly coupled to the port and located inside the container when the base portion is coupled to the container.

The internal and external fluid conduits may be different portions of a flexible tube.

The dispenser may also include a sealing element that is positioned between the external fluid conduit and the perimeter of the port to create a fluidic seal between the external fluid conduit and the perimeter of the port.

The sealing element can include a hollow member inserted through the port through which the fluid exiting the container passes, wherein the hollow member has wrapped on one end portion the external fluid conduit and wrapped on another end portion the internal fluid conduit and wherein the external fluid conduit is sandwiched between the hollow member and the perimeter of the port; and a fluid conduit flange located on the hollow member between the hollow member and the external fluid conduit that helps retain the external fluid conduit on the hollow member.

The dispenser may also include an internal flange located on a portion of the hollow member located within the container when the base portion is coupled to the container and sized to press against a surface around the port to prevent the sealing element from being pulled from the container.

The dispenser may also include a conduit retaining unit coupled to the internal fluid conduit. The conduit retaining unit can have a plurality of arms each being sufficiently long to press against the interior of the container such that the conduit retaining unit is secured within the container when located therein.

The dispenser may also include a flavour dispensing unit fluidly coupled to an end of the internal fluid conduit into which the fluid enters. The flavour dispensing unit may have a housing having an inlet into which the fluid is drawn and an outlet fluidly coupled to the end of the internal fluid conduit into which the fluid enters; a flavour block contained within the housing; and a fluid channel through which the fluid passes as it travels from the inlet to the outlet and fluidly coupled to the flavour block such that portions of the flavour block dissolve into the fluid as the fluid flows through the fluid channel.

The base portion may be threaded to allow it to be directly screwed on to the container and over a mouth of the container. The base portion, except for the port, can seal the mouth of the container. The base portion may also have a planar surface via which the base portion may be mounted on to a bottle cap.

This summary does not necessarily describe the entire scope of all aspects. Other aspects, features and advantages will be apparent to those of ordinary skill in the art upon review of the following description of specific embodiments.

### DETAILED DESCRIPTION

Directional terms such as “top”, “bottom”, “upwards”, “downwards”, “vertically” and “laterally” are used in the following description for the purpose of providing relative reference only, and are not intended to suggest any limitations on how any article is to be positioned during use, or to be mounted in an assembly or relative to an environment.

Several problems and challenges arise when dispensing a carbonated beverage from a bottle. One problem is that repeatedly removing a bottle cap from the bottle releases the carbon dioxide contained in the bottle and therefore tends to cause the beverage to go flat over time. This makes the beverage less pleasant to drink, and can result in consumers discarding the beverage instead of drinking it. Alternatives exist to bottle caps that have to be removed each time the beverage is to be dispensed. For example, some types of dispensers for containers utilize a piston assembly in which a consumer reciprocates the piston in order to pump a liquid, such as a beverage, from the container. Detrimentally, however, these piston-type dispensers require pumping, which can be cumbersome, and are relatively complex in that they typically rely on springs, which can increase manufacturing and maintenance costs. Another type of dispenser is one that utilizes a carbon dioxide cartridge to drive the liquid out of the container. The use of such a cartridge, however, again introduces cost and complexity to the manufacturing and maintenance process.

Other kinds of dispensers that do not have to be removed in order to dispense liquids from a container typically suffer from similar faults. For example, it is common for such dispensers to utilize a flow path that results in the liquid being splashed and agitated as it exits the container, which can cause a carbonated beverage to go flat. Furthermore, these dispensers often rely on gaskets used to seal valve assemblies or other similar seals to prevent leakage from the container; over time, these gaskets can fail and leaking can result. Additionally, the relative complexity of these dispensers often results in their being made from a variety of different materials, which can render them not recyclable.

The embodiments described herein are directed at a dispenser for a container (such as a bottle) that can be used to dispense fluids, such as carbonated beverages and other liquids, from the container. Without removing the dispenser from the container, the dispenser can be used to seal the container shut and to dispense the fluids from the container. In order to seal the container, a flexible fluid conduit, such as a flexible tube, is squeezed shut. Squeezing the conduit shut does not require a gasket or other similar type of seal, and therefore is more resilient and reliable than many types of conventional dispensers. In some embodiments the liquid is dispensed from the container through the flexible fluid conduit and then directly out of the dispenser. In these embodiments, the liquid flows smoothly and with relatively minimal agitation through the flexible fluid conduit, which can help prevent the liquid from losing carbonation.

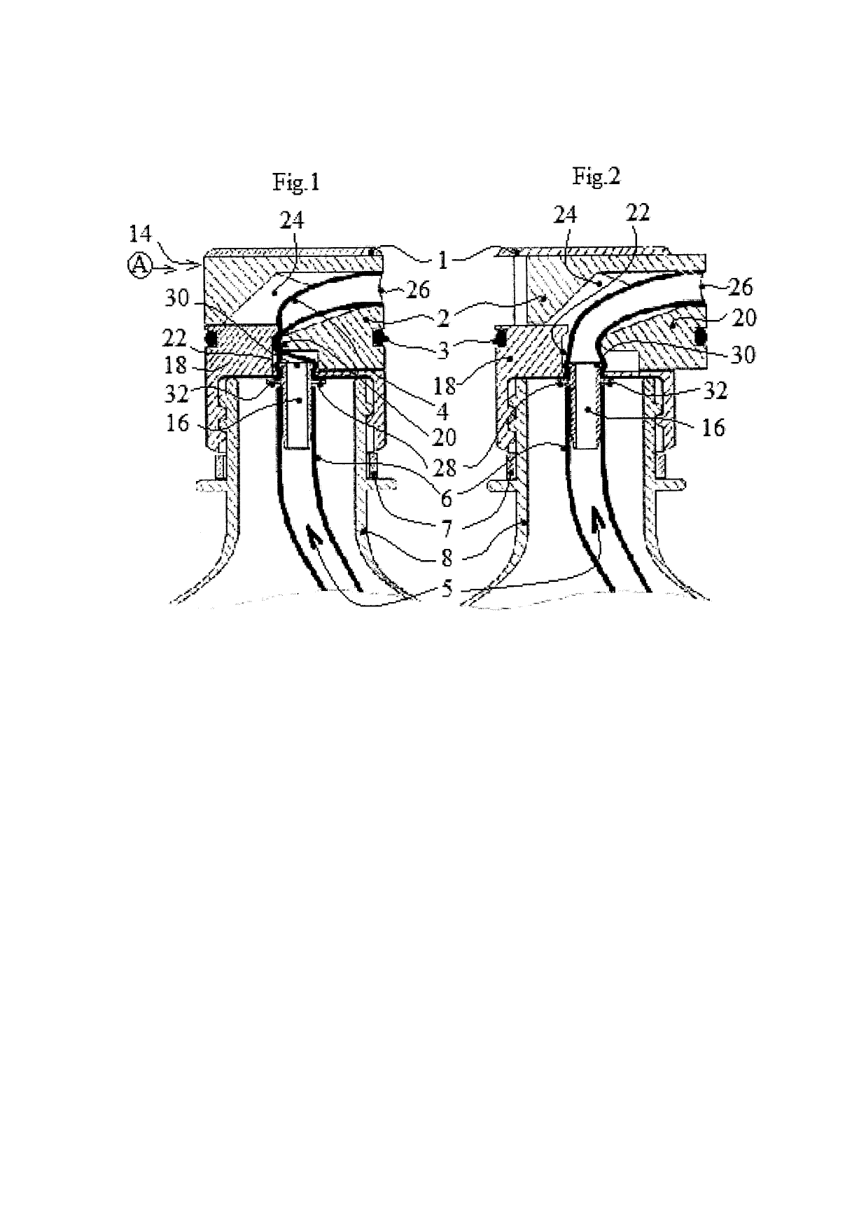

Referring now to FIGS. 1 and 2, there are depicted side sectional views of one embodiment of a dispenser 14 attached to a container 8. In FIG. 1, the dispenser 14 is in a closed position and fluid (not shown) contained within the container 8 is sealed within the container. In FIG. 2, the dispenser 14 is in an opened position and the fluid contained within the container 8 can flow out of the container 8.

The dispenser 14 has a base portion 1 that is attached to the container 8 by virtue of being screwed on to a neck of the container 8. At the bottom of the base portion 1 is a ring 7 to which the base portion 1 is frangibly connected, and which helps to keep the base portion 1 from inadvertently being screwed off of the container 8. The base portion 1 covers the entire mouth of the container 8 with the exception of a portion of the container 8's mouth left uncovered by a port 16 in the base portion 1. Fluid exiting the container 8 exits via the port 16. On the outside of the container 8, an external flexible fluid conduit 4 is present and is fluidly coupled to the port 16. The fluid exiting the container 8 travels through the port 16, into the external fluid conduit 4, and then out of an outer surface of the dispenser 1 when the fluid is dispensed.

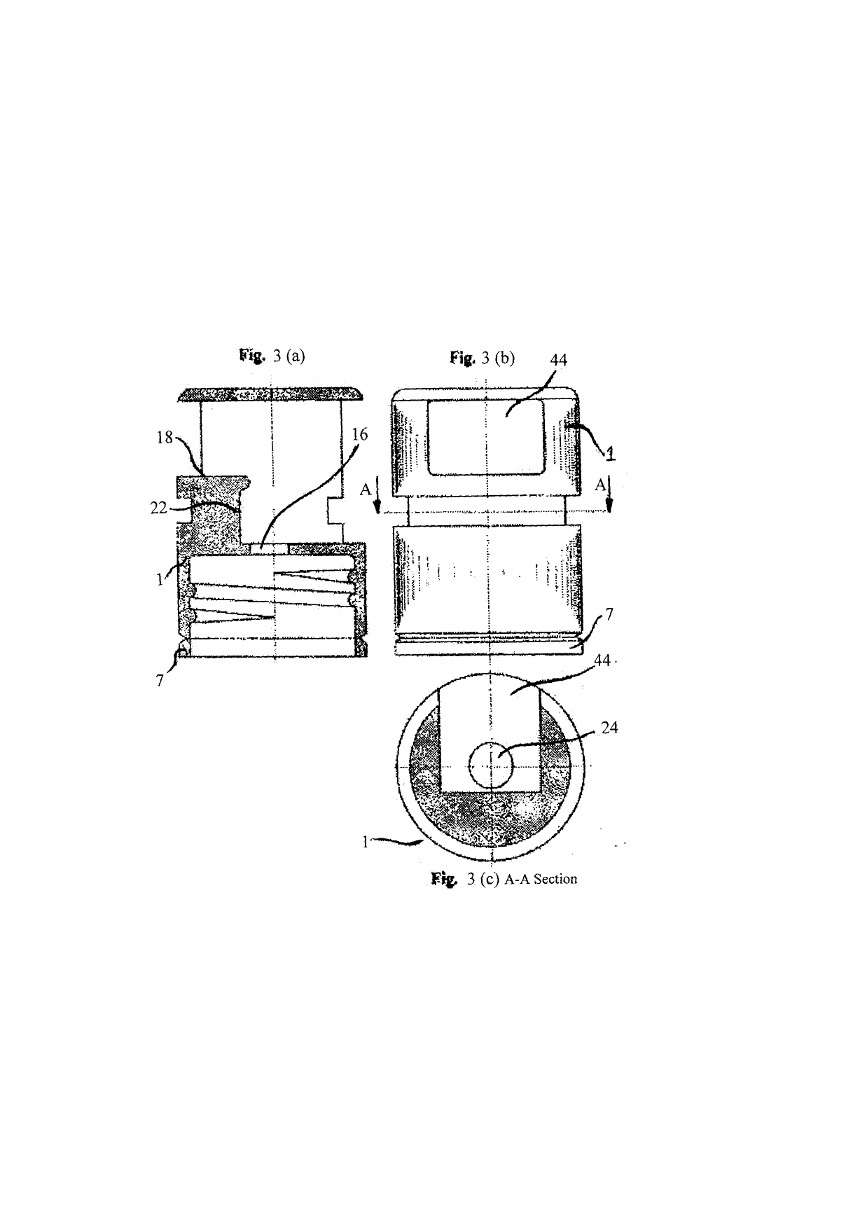

As also shown from different perspectives in FIGS. 3(b) and (c), discussed below, the base portion 1 has a channel 44 into which a squeezing element 2 is inserted and along which the squeezing element 2 is slidable. The squeezing element 2 includes a projection 20 that is slidable towards a shoulder 18 that forms part of the base 1. Between the shoulder 18 and the projection 20 is the external fluid conduit 4. In FIG. 1, the squeezing element 2 is positioned such that the projection 20 squeezes the external fluid conduit 4 against the shoulder 18 in order to prevent any of the fluid within the container 8 from travelling through the external fluid conduit 4; in this state, the squeezing element 2 is referred to as being in the “closed” position. With sufficient force, the squeezing element 2 can squeeze the external fluid conduit 4 shut to stop any fluid in the container 8 from travelling through the external fluid conduit 4 when in the closed position. In FIG. 2, the squeezing element 2 is positioned to apply relatively less force to the external fluid conduit 4 such that the external fluid conduit 4 is sufficiently released to allow the fluid exiting the container 8 through the port 16 to travel through the external fluid conduit 4; in this state, the squeezing element 2 is referred to as being in the “opened” position. A tension band 3 is wrapped around the exteriors of the shoulder 18 and the squeezing element 2 in order to bias the squeezing element 2 into the closed position. When a consumer wants to dispense the fluid, the consumer may push the squeezing element 2 at the location labelled “A” in FIG. 1 such that the biasing force of the tension band 3 is overcome and the squeezing element 2 transitions to the opened position. When the consumer ceases pushing, the force from the tension band 3 causes the squeezing element 2 to return to the closed position.

In FIGS. 1, 2, 13, and 14 the dispenser 14 includes a sealing element 5 that is inserted through the port 16 and that helps maintain a fluid tight seal between the external fluid conduit 4 and the container 8. The sealing element 5 includes a hollow member 28 that is inserted through the port 16 and that has wrapped on one end portion of the external fluid conduit 4. At an end of the hollow member 28 that is located outside of the container 8 is an external flange 30. The external fluid conduit 4 is sheathed over the external flange 30 and is sandwiched at a point along its length between the perimeter of the port 16 and the hollow member 28. This compression of the external fluid conduit 4 between the perimeter of the port 16 and the hollow member 28 helps to create a fluidic seal between the external fluid conduit 4 and the perimeter of the port 16. The fluidic seal not only helps to prevent liquid from inadvertently escaping from the container 8, but helps to prevent gas from escaping as well, which is particularly beneficial when dispensing carbonated beverages.

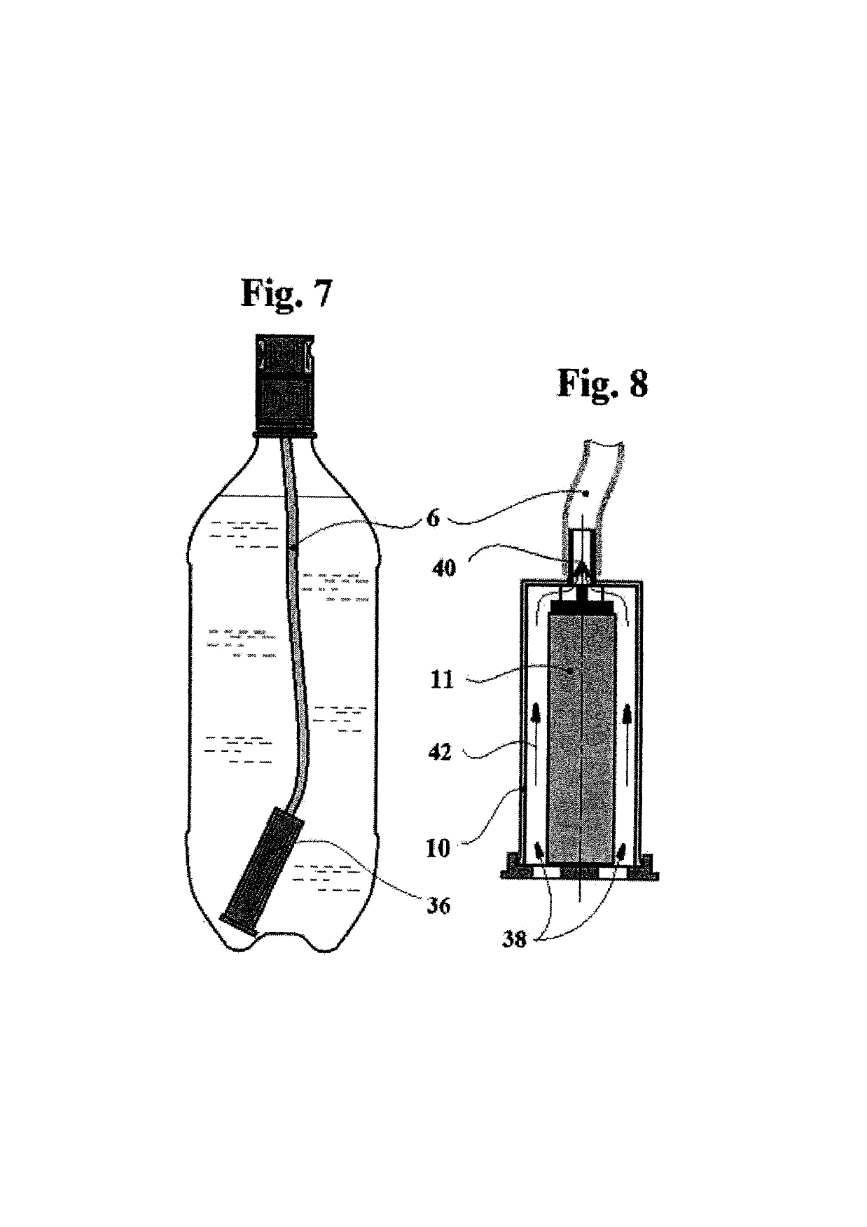

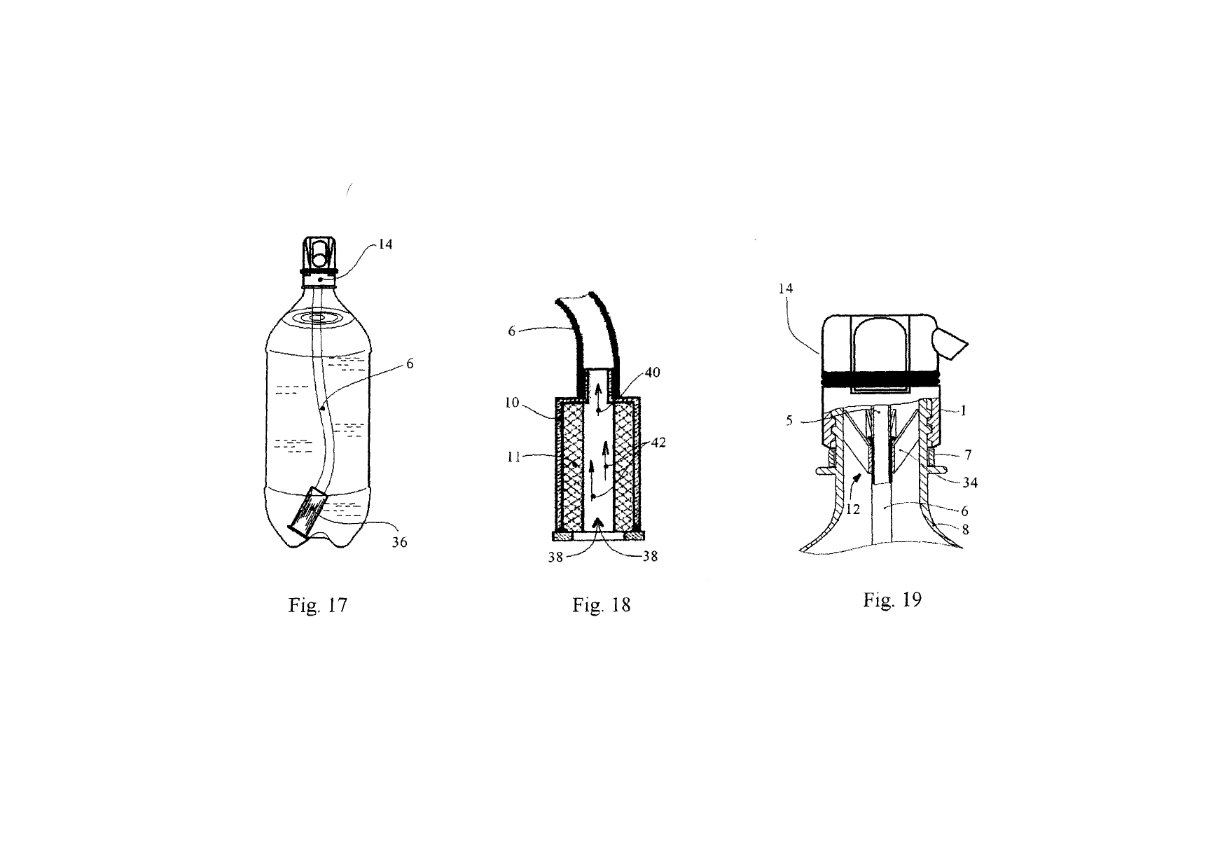

On the portion of the sealing element 5 located within the container 8, there is an internal fluid conduit 6 wrapped on the other end portion of the hollow member 28. As shown in FIGS. 7 and 17, the internal fluid conduit 6 extends downwards into the container 8 and, when the container 8 is sufficiently filled with liquid, the end of the internal fluid conduit 6 not attached to the sealing element 5 is submerged in the liquid. Consequently, assuming all seals are functioning properly, only or primarily the liquid is dispensed from the container 8 via the internal fluid conduit 6, and undissolved gases do not escape the container 8 in any significant amount.

The sealing element 5 also includes an internal flange 32 that is located on the hollow member 28 on the inside of the container 8. The internal flange 32 is sized to press against a surface of the base portion 1 around the port 16 to prevent the sealing element 5 from being pulled out of the container 8. Consequently, tension in the external fluid conduit 4 does not result in the sealing element 5 becoming dislodged.

Within the squeezing element 2 is an exit path 24 along which the external fluid conduit 4 extends. The exit path 24 terminates in a dispenser opening 26 in the outer surface of the dispenser 14. The external fluid conduit 4 extends from the port 16, through the exit path 24, and also terminates at and is secured to the dispenser opening 26. Liquid being dispensed from the container 8 consequently is channelled entirely within the external fluid conduit 4 until it exits through the dispenser opening 26. Beneficially, this prevents the liquid from directly contacting the portions of the base portion 1 and the squeezing element 2 that collectively delineate the exit path 24 while being dispensed, which reduces the amount of agitation and turbulent flow the liquid undergoes during dispensing and facilitates retention of dissolved gases in the liquid. Additionally, as the liquid does not come into contact with these portions of the base portion 1 or the squeezing element 2 located along the exit path 24, residue from the liquid that could impair the ability of the squeezing element 2 to slide between the opened and closed positions does not have the opportunity to form on either the base portion 1 or the squeezing element 2. Furthermore, the dispensed liquid cannot become contaminated by either the base portion 1 or the squeezing element 2.

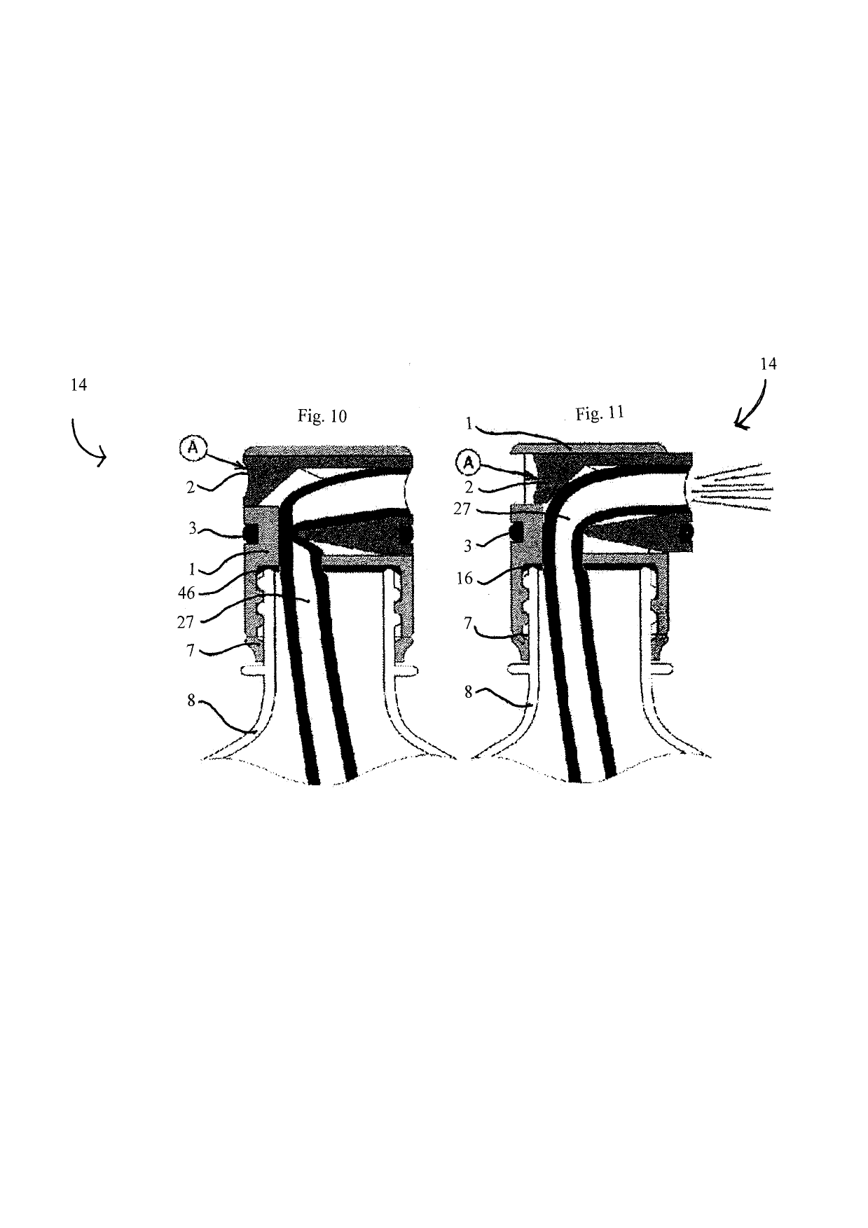

Referring now to FIGS. 10 and 11, there is shown another embodiment of the dispenser 14 that is similar to the embodiment of the dispenser 14 shown in FIGS. 1 and 2 in that it is coupled directly to the neck of the container 8 but which lacks the sealing element 5. The external and internal fluid conduits 4, 6 of the dispenser 14 shown in FIGS. 10 and 11 are different portions of a single flexible tube 27 that extends continuously from within the container 8, through the port 16, through the exit path 24 and that terminates at the dispenser opening 26. Optionally, an adhesive may be applied between the flexible tube 27 and the perimeter of the port 16 to create a seal between the tube 27 and the perimeter of the port 16. FIGS. 10 and 11 also show a bottle cap gasket 46 used to help ensure liquids do not leak out between the neck of the container 8 and the base portion 1. The bottle cap gasket 46 may also be used in conjunction with the embodiments shown in FIGS. 1 and 2, and the other embodiments discussed herein.

Referring now to FIGS. 3(a)-(c), there are shown sectional and front elevation views of the base portion 1. FIG. 3(a) shows a sectional view of the base portion 1 in which the threads on the base portion 1, used to screw the base portion 1 on to the neck of the container 8, are emphasized. A frangible connection between the base portion 1 and the ring 7 allows the consumer to unscrew the dispenser 14 from the container 8 if so desired. The port 16 in the base portion 1 leads directly into the channel 44 into which the squeezing element 2 is insertable. As shown in FIGS. 3(b) and (c), the width of the channel 44 in the depicted embodiment does not extend across the entire width of the base portion 1. However, in alternative embodiments (not depicted), the channel 44 may extend across the entire width of the base portion 1, and in a subset of these alternative embodiments the top of the base portion 1 may accordingly be covered entirely by the squeezing element 2.

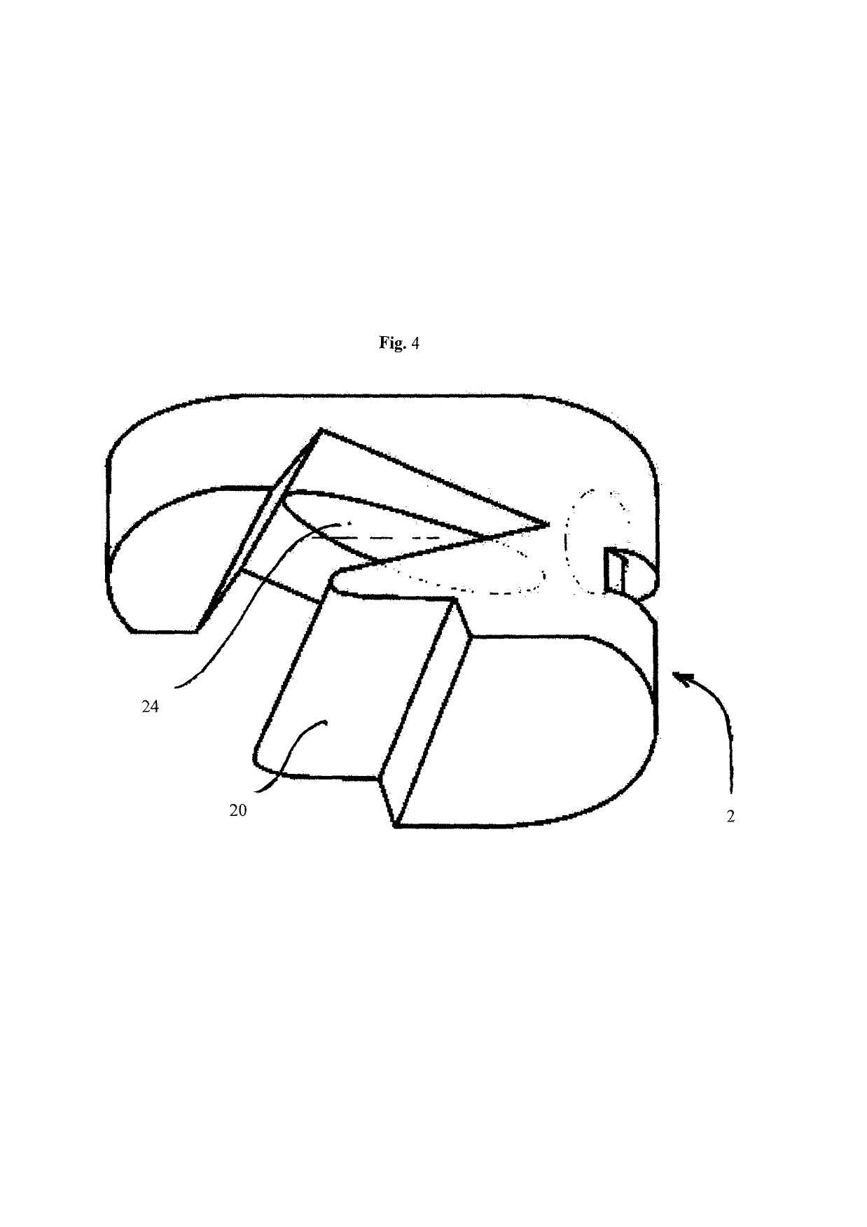

Referring now to FIG. 4, there is shown a perspective view of the squeezing element 2 showing the exit path 24, a notch into which the tension band 3 is fitted, and the projection 20 used to squeeze the external fluid conduit 4. In the depicted embodiment the projection 20 is a single protrusion extending from ₜhe body of the squeezing element 2. However, in alternative embodiments the projection 20 may include multiple protrusions extending from the body of the squeezing element 2 that squeeze the external fluid conduit 4 at different positions. For example, the projection 20 may be composed of multiple protrusions aligned one on top of the other so that the external fluid conduit 4 is squeezed shut at multiple locations along its length, which can result in a relatively more robust seal.

Additionally, while the depicted embodiments of the dispenser 14 utilize the tension band 3 to bias the squeezing element 2 into the closed position, in alternative embodiments (not depicted) different mechanisms may be used to bias the squeezing element 2. For example, a latch located on the exterior of the dispenser 14 and spanning the squeezing element 2 and the base portion 1 may be used to secure the squeezing element 2 in place.

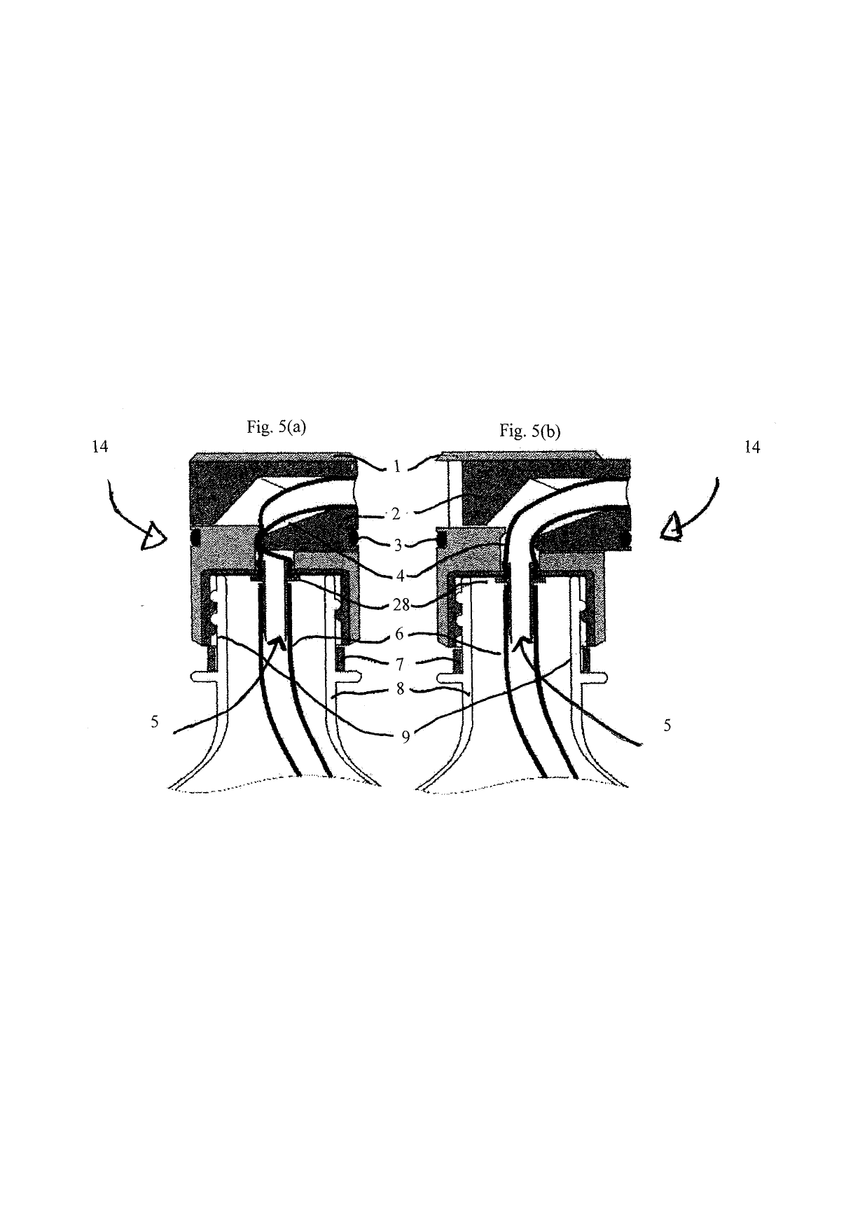

Referring now to FIGS. 5(a) and (b), there are shown sectional views of an embodiment of the dispenser 14 in which the base portion 1 of the dispenser 14 is mounted to a conventional bottle cap 9, and thereby indirectly coupled to the container 8. In this embodiment the conventional bottle cap 9 is threaded and screwed on to the neck of the container 8, while the remainder of the base portion 1 is secured on to the conventional bottle cap 9 via, for example, an adhesive. The surface of the base portion 1 that contacts the bottle cap 9 is planar to facilitate mounting of the base portion 1 on to the bottle cap 9. The conventional bottle cap 9 includes the ring 7 wrapped around the base of the neck of the container 8. Beneath the port 16 of this embodiment is a gap in the conventional bottle cap 9 through which the external fluid conduit 4 passes. The diameter of the port 16 is larger than the diameter of the gap in the conventional bottle cap 9. Consequently, the sealing element 5 of the embodiments of FIGS. 5(a) and (b) creates a seal between the external fluid conduit 4 and the perimeter of the gap in the conventional bottle cap 9 as opposed to between the external fluid conduit 4 and the port 16. The remainder of the dispenser 14 depicted in FIGS. 5(a) and (b) is substantially similar to the dispenser 14 shown in FIGS. 1 and 2.

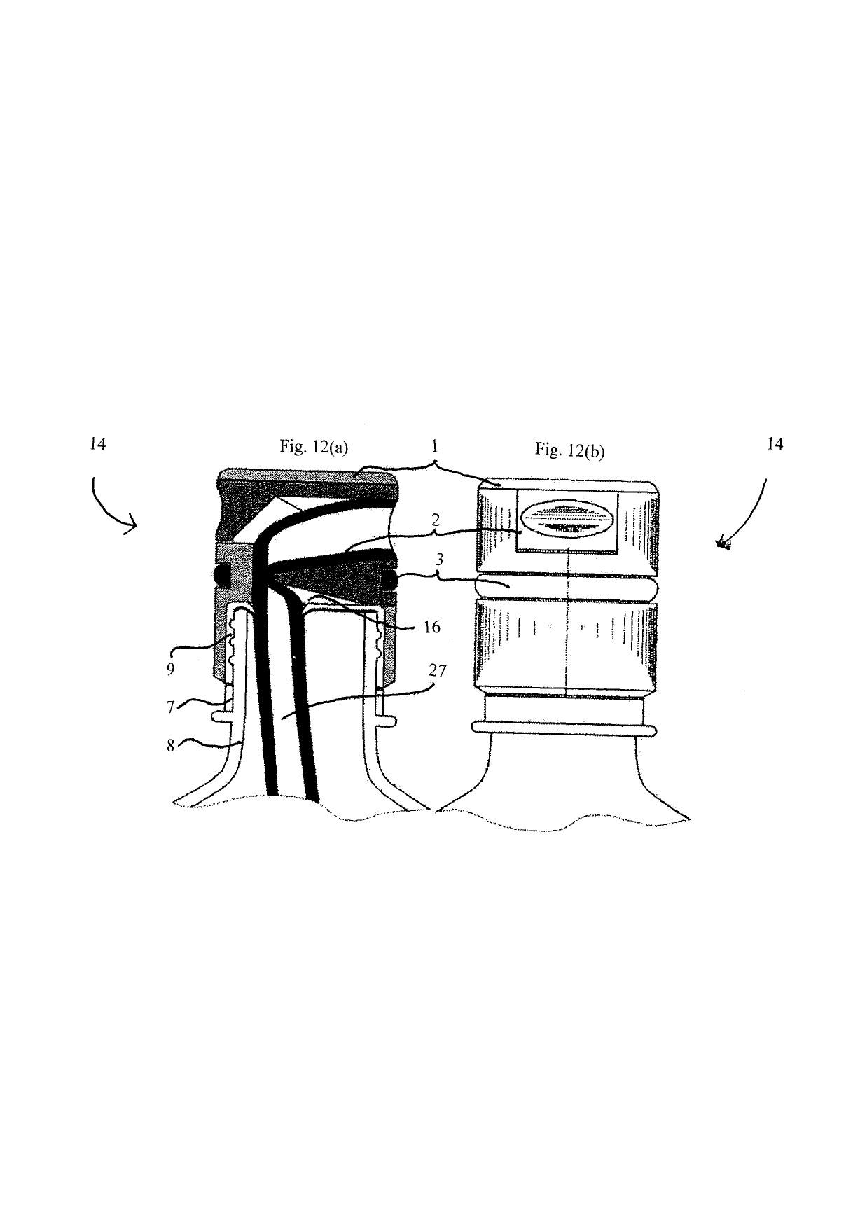

Referring now to FIGS. 12(a) and 12(b), there are shown embodiments of the dispenser 14 in which the dispenser 14 lacks the sealing element 5 and in which the base portion 1 is mounted on the conventional bottle cap 9. As with the embodiments shown in FIGS. 10 and 11, the external and internal fluid conduits 4, 6 of the dispenser 14 shown in FIGS. 12(a) and 12(b) are different portions of the single flexible tube 27 that extends continuously from within the container 8, through a gap in the conventional bottle cap 9 and through the port 16, through the exit path 24 and that terminates at the dispenser opening 26. Optionally, an adhesive may be applied between the flexible tube 27 and the gap in the conventional bottle cap 9 to create a seal between the tube 27 and the conventional bottle cap 9. In the embodiment shown in FIGS. 12(a) and 12(b), the width of the port 16 is substantially larger than the width of the gap in the conventional bottle cap 9.

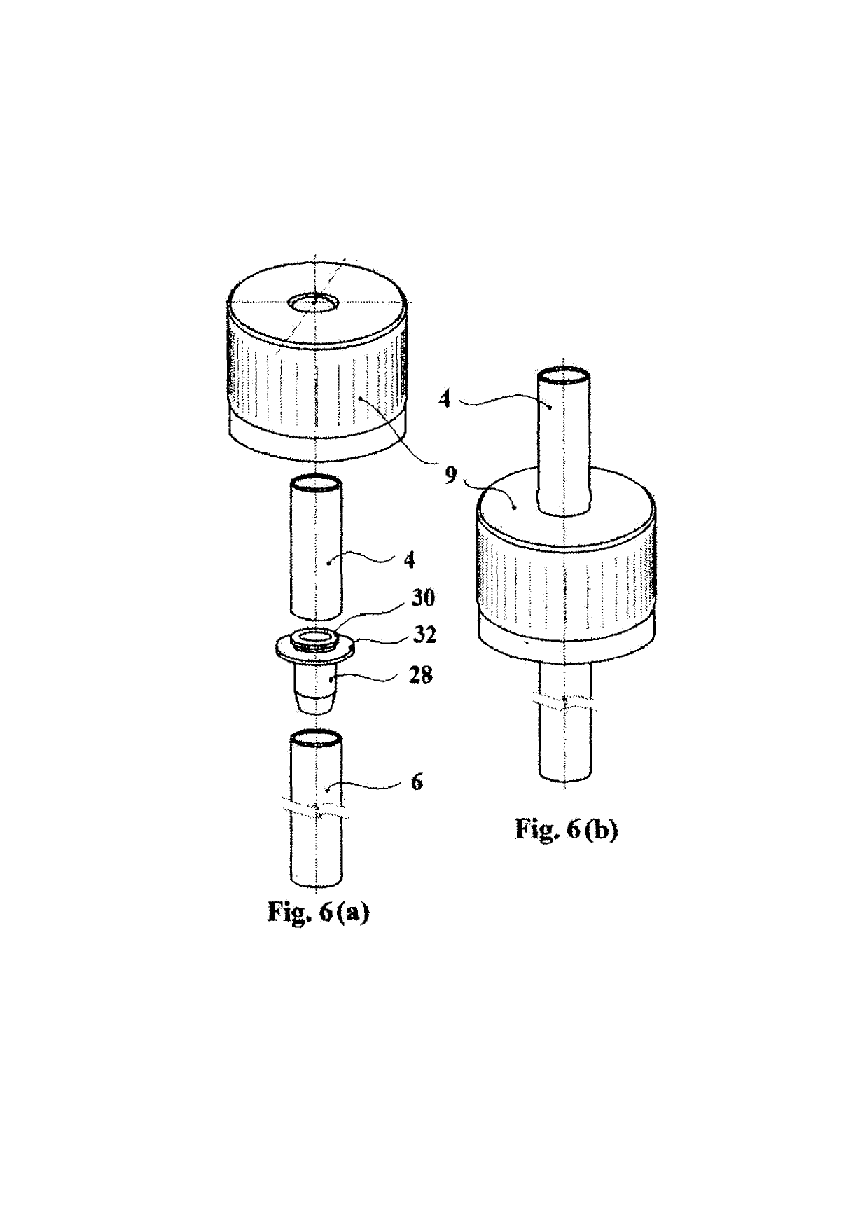

Referring now to FIGS. 6(a) and 6(b), there are respectively shown exploded and perspective views of the conventional bottle cap 9, external fluid conduit 4, sealing element 5, and internal fluid conduit 6 of the dispenser 14 of FIGS. 5(a) and 5(b). In order to assemble these four components together, the internal fluid conduit 6 is first pushed on to the lower end of the sealing element 5. The external fluid conduit 4 is then pushed on to the upper end of the sealing element 5 until it abuts against the top of the internal flange 32. The external fluid conduit 4 is then inserted through the port 16 in the conventional bottle cap 9 until the external flange 30 passes through the port 16. This helps to create the fluidic seal between the external fluid conduit 4 and the perimeter of the port 16. Following assembly of the conventional bottle cap 9, external and internal fluid conduits 4, 6, and the sealing element 5, the remainder of the base portion 1 can be mounted on to the conventional bottle cap 9 to continue assembly of the dispenser 1.

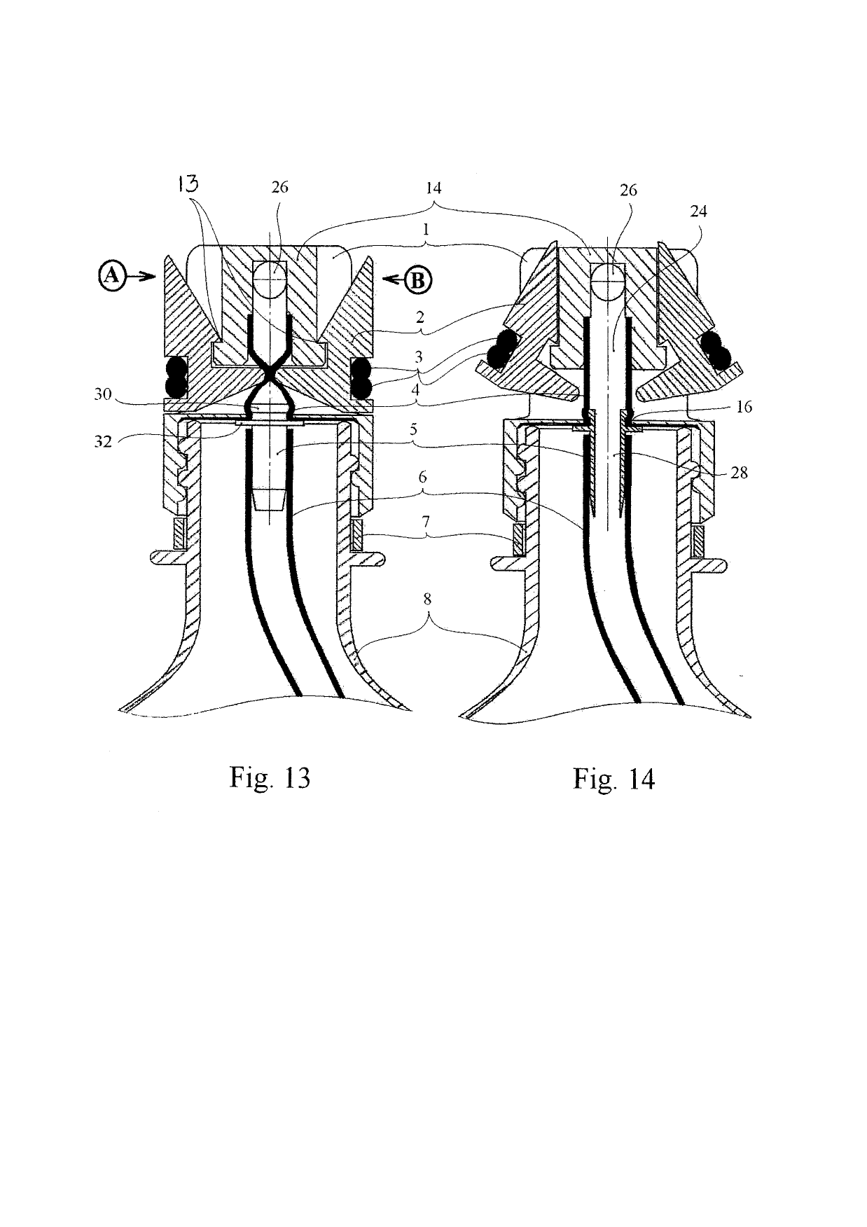

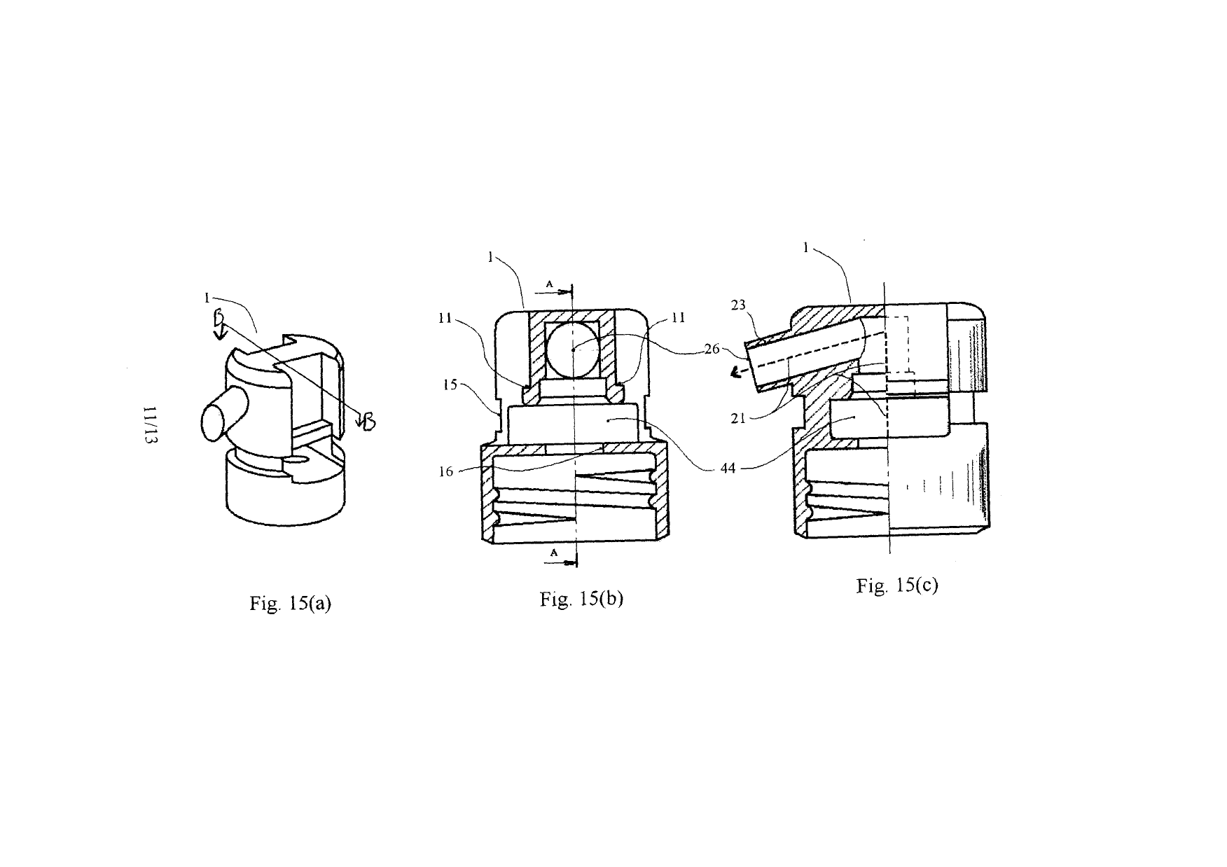

Referring now to FIGS. 13 and 14, there are shown sectional views of another embodiment of the dispenser 14, which in several respects is substantially similar to the dispenser 14 shown in FIGS. 1 and 2. The dispenser 14 of FIGS. 13 and 14 includes the base portion 1 with the port 16 that is secured over the mouth of the container 8, and the external flexible fluid conduit 4 coupled to the port 16 that provides a pathway for any fluids inside the container 8 to flow to the opening 26 on the surface of the dispenser 14. However, instead of the single squeezing element 2 shown in the dispenser 14 of FIGS. 1 and 2, the dispenser 14 shown in FIGS. 13 and 14 include a pair of squeezing elements 2 that are pivotally coupled to the base portion 1, as discussed in more detail in respect of FIGS. 15(a)-(c) and 16(a)-(c), below. The pair of squeezing elements 2 pivots between a closed position in which they collectively squeeze the external fluid conduit 4 shut to prevent any fluid in the container 8 from flowing out through it, and an opened position in which the squeezing elements 2 are positioned such that the fluid can flow out through the external fluid conduit 4.

Also as shown in FIGS. 13 and 14, each of the squeezing elements 2 includes the projection 20. When the squeezing elements 2 are in the closed position, the projections 20 collectively shut the external fluid conduit 4 by pinching it. When in the opened position, the projections 20 do not pinch the external fluid conduit 4 shut, and fluid can accordingly flow through it and exit the container 8. The tension band 3 is wrapped around the exterior of the base portion 1 and squeezing elements 2 in order to bias the squeezing elements 2 into the closed position.

While FIGS. 13 and 14 show the squeezing elements 2 pivotally coupled to the base portion 1, in other embodiments the squeezing elements 2 may be coupled to the base portion 1 in alternative ways. For example, the squeezing elements 2 may be slidingly coupled to the base portion 1 along individual channels or rails, or may be rotationally coupled about a hinge, joint, or the like. Further, the squeezing elements 2 in the depicted embodiment are identical to each other and symmetrically positioned about the external fluid conduit 4, in other embodiments the squeezing elements 2 may be shaped differently from each other and additionally or alternatively may be asymmetrically positioned about the external fluid conduit 4. For example, in one alternative embodiment the projection 20 of one of the squeezing elements 2 may include a channel (not shown) shaped to receive the external fluid conduit 4 when the squeezing elements 2 are in the closed position.

Referring now to FIGS. 15(a) to (c), are is shown perspective, front sectional, and side cutaway views of an embodiment of the base element 1 that forms part of the dispenser 14 shown in FIGS. 13 and 14. FIGS. 15(b) and (c) in particular emphasize threads inside the base portion 1 that are used to screw the base portion 1 on to the neck of the container 8. The base portion 1 includes the port 16 that allows access to the container 8′s interior, the channels 44 into which the squeezing elements 2 are insertable, and the opening 26 from which fluid may exit the dispenser 14. This embodiment of the base portion 1 also includes a spout 23. The channels 44 allow access to the external flexible fluid conduit 4 (not shown in FIGS. 15(a) to (c)), which is routed up the middle of ₜhe base portion 1. The base portion 1 also has ledges 11 on which the squeezing elements 2 pivot, and a groove 15 surrounding the exterior of the base portion 1 into which the tension band 3 can be inserted. The external flexible fluid conduit 4 can be routed within the base portion 1 to fluidly couple the port 16 to the opening 26 through the channel 44 and along the flow path 21 indicated by the dashed line in FIG. 15(c).

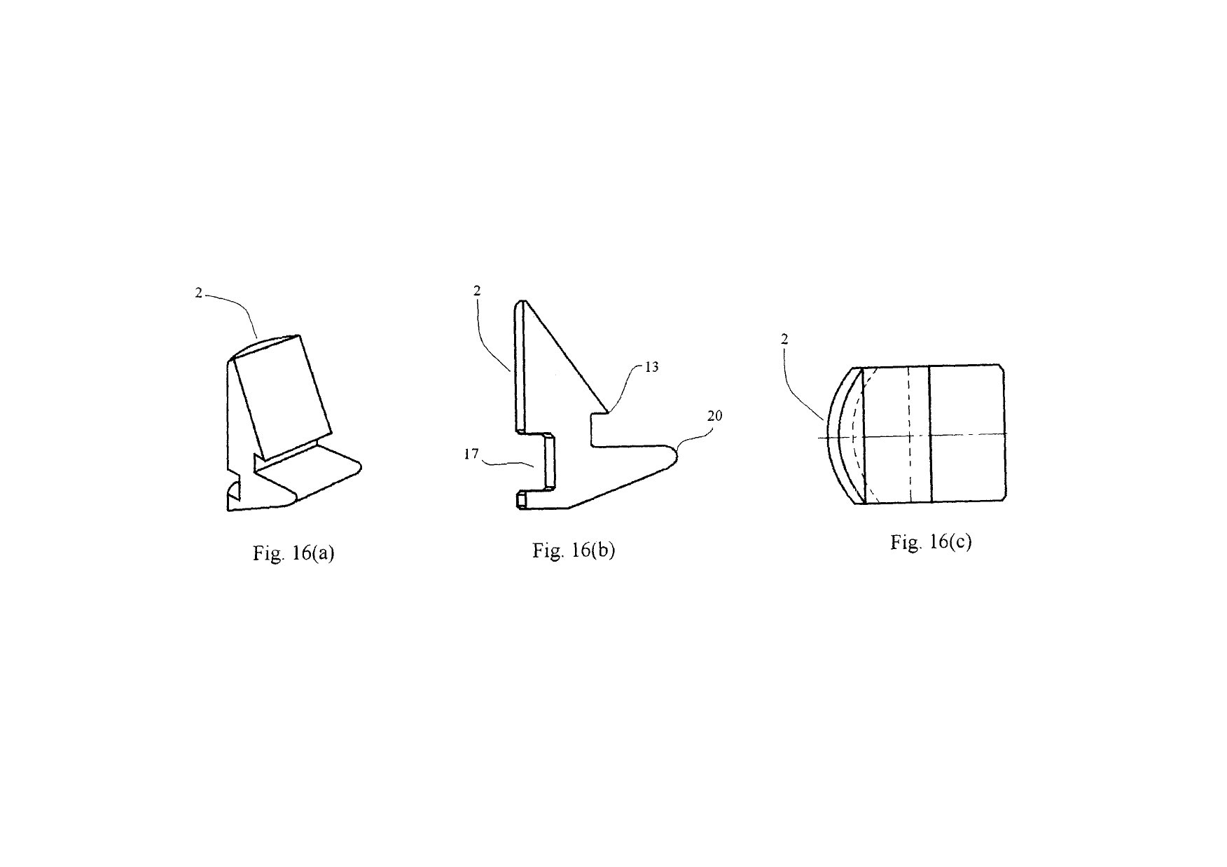

Referring to FIGS. 16(a) to (c), there are shown perspective, side elevation, and top plan views of an embodiment of the squeezing element 2 that forms part of the dispenser 14 shown in FIGS. 13 and 14. The squeezing element 2 includes a main body that has a fulcrum 13, the projection 20, and a notch 17. The fulcrum 13 is triangular and is shaped to sit on the ledge 11 of the base portion 1 to allow the squeezing element 2 to pivot between the opened and closed positions. As the squeezing element 2 moves between the opened and closed positions, the projection 20 moves through the channel 44 and squeezes the external flexible fluid conduit 4 (not shown in FIGS. 16(a)-(c)). The tension band 3 is inserted into the notch 17 and biases the squeezing element 2 to the closed position. A consumer can dispense fluid from the container 8 by squeezing the squeezing elements 2 at the locations labelled “A” and “B” in FIG. 13 such that the biasing force of the tension band 3 is overcome and the squeezing elements 2 transition to the opened position. When the consumer lets go of the dispenser 14, the tension band 3 returns the squeezing elements 2 to the closed position, and the projections 20 pinch the external fluid conduit 4 shut.

In the embodiments depicted above, the projection 20 is a single protrusion extending from the body of the squeezing element 2. In alternative embodiments (not shown) the projection 20 may include multiple protrusions extending from the body of the squeezing element 2 that squeeze the external fluid conduit 4 at different positions. For example, the projection 20 may be composed of multiple protrusions aligned one on top of the other so that the external fluid conduit 4 is squeezed shut at multiple locations along its length, which can result in a relatively more robust seal. Additionally, while the depicted embodiments of the dispenser 14 in FIGS. 13 and 14 utilize the tension band 3 to bias the squeezing elements 2 into the closed position, in alternative embodiments (not depicted) different mechanisms may be used to bias the squeezing element 2. For example, a latch located on the exterior of the dispenser 14 and spanning the squeezing elements 2 and the base portion 1 may be used to lock the squeezing elements 2 in place.

Referring now to FIGS. 7 and 17, there are shown side elevation views of the dispenser 14 attached to the container 8, in which the internal fluid conduit 6 extends into the container 8 and is fluidly coupled to a flavour dispensing unit 36. FIGS. 8 and 18 are sectional views of embodiments of the flavour dispensing unit 36. The flavour dispensing unit 36 includes a housing 10 that has an inlet 38 for drawing the liquid into the flavour dispensing unit 36, an outlet 40 through which the liquid exits the flavour dispensing unit 36 and enters the internal fluid conduit 6, and a fluid channel 42 that fluidly couples the inlet 38 and the outlet 40. A flavour block 11 is disposed within the housing 10 of the flavour dispensing unit 36, and may be disposed centrally and surrounded by the fluid channel 42 as shown in as shown in FIG. 8, or may line the inner surface of the housing 10 surrounding the fluid channel 42 as shown in FIG. 18. The flavour block 11 may, for example, be made from a hard candy or from a sugar free, hard pressed compound. Liquid that is being dispensed from the container 8 is drawn in through the inlet 38, comes into contact with the flavour block 11 as it passes through the fluid channel 42, and then exits through the outlet 40. As the fluid flows by the flavour block 11 portions of the flavour block 11 dissolve into the fluid. In this way flavour may be added to the liquid being dispensed and the bottler may be able to customize the beverages being sold.

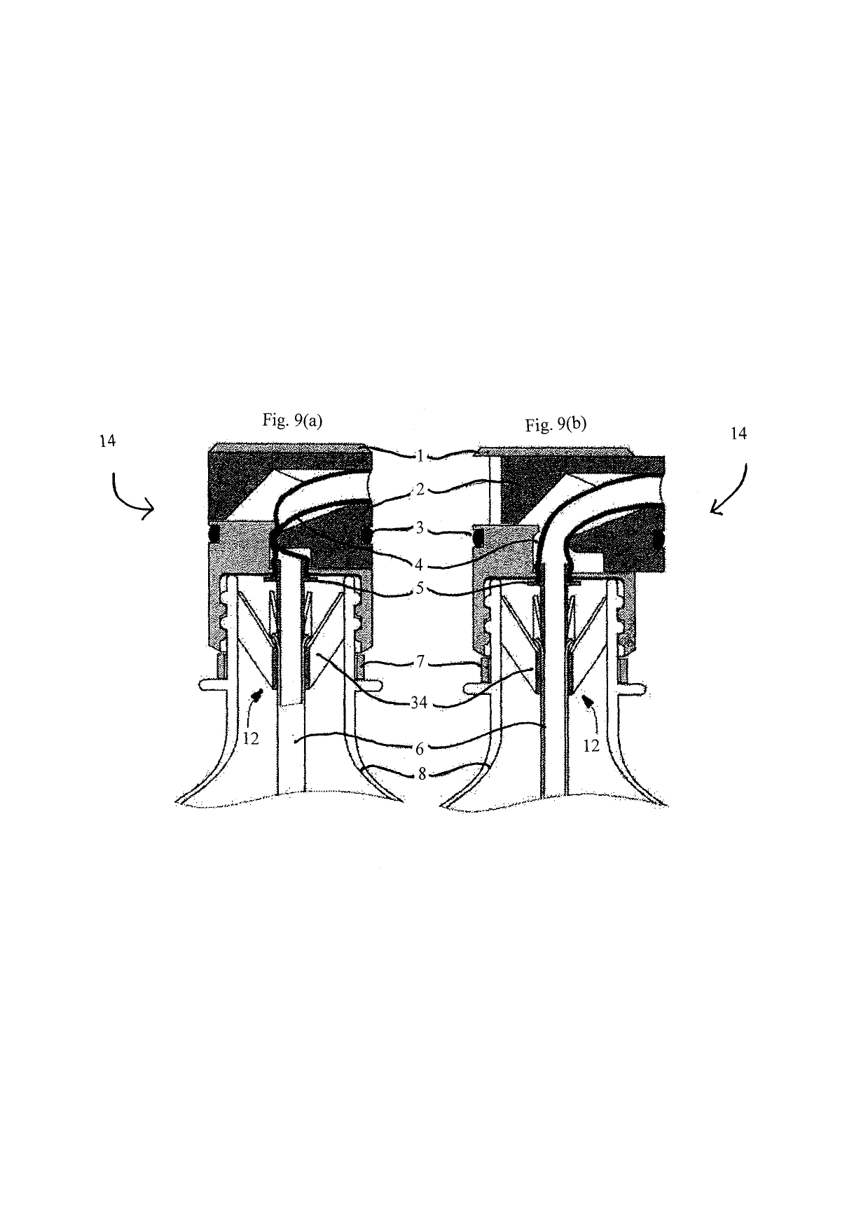

Referring now to FIGS. 9(a),9(b), and 19, there are shown sectional views of an embodiment of the dispenser 14. Specifically, FIGS. 9(a) and (b) show a dispenser 14 in the closed and opened positions that is substantially similar to the embodiment of the dispenser 14 shown in FIGS. 1 and 2, while FIG. 19 shows a dispenser 14 that is substantially similar to the embodiment shown in FIGS. 13 and 14. However, these embodiments differ in that they further include a conduit retaining unit 12 used to retain the internal fluid conduit 6 in place. As further discussed below, use of the conduit retaining unit 12 is particularly beneficial when caps 9 are being applied to the containers 8 automatically in a bottling plant in order to secure and align the internal fluid conduit 6.

In a bottling plant assembly line, the conduit retaining unit 12 is first secured to the internal fluid conduit 6. To facilitate automatic assembly, the internal fluid conduit 6 may be stiff. The conduit retaining unit 12 includes multiple arms 34. The arms 34 may be individually affixed to the internal fluid conduit 6 using, for example, an adhesive. Alternatively, the arms 34 may extend outwards from a central ring (not shown) that can be slid on to the internal fluid conduit 6. As shown in FIGS. 9(a), 9(b), and 19, the top of the internal fluid conduit 6 may be flared to help retain the arms 34 on the internal fluid conduit 6.

Once the conduit retaining unit 12 is affixed to the internal fluid conduit 6, the conduit 6 can be inserted through the neck of the container 8. The arms 34 of the conduit retaining unit 12 press against the interior of the neck of the container 8 and help to keep the internal fluid conduit 6 centred within the bottle. The base portion 1, sealing element 5, squeezing element 2, tension band 3, and external fluid conduit 4, which are typically pre-assembled prior to being shipped to the bottling plant, are then attached to the container 8. In embodiments in which the base portion 1 is threaded, this is done by screwing the base portion 1 on to the neck of the container 8. When the internal fluid conduit 6 is properly aligned by the conduit retaining unit 12, the hollow member 28 of the sealing unit 5 is inserted into and frictionally retained by the internal fluid conduit 6.

Following attachment of the dispenser 14 to the container 8, liquid from the container 8 can be dispensed. If the liquid is a sufficiently carbonated beverage, the liquid can be dispensed simply by pushing the squeezing element(s) 2 into its opened position. The gas pressure within the container 8 is sufficient to drive the beverage through the flavour dispensing unit 36, up through the internal and external fluid conduits 6, 4, and out through the dispenser opening 26. Alternatively, if there is insufficient gas pressure to dispense the liquid, the container 8 can be tipped and the liquid may be poured from the container 8.

In the depicted embodiments, the base portion 1 and the squeezing element(s) 2 can be made of polyethylene; the tension band 3 can be made of rubber or another suitable elastic material; and the internal (in embodiments in which it is flexible) and external fluid conduits 6, 4 can be made from FDA approved silicone. Alternative, suitable materials can also be used to construct the foregoing embodiments.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A dispenser for a container, the dispenser comprising:
(a) a base portion couplable to the container, wherein the base portion comprises a port through which fluid exiting the container passes when the base portion is coupled to the container;
(b) an external flexible fluid conduit fluidly coupled to the port, wherein the external fluid conduit is located outside of the container when the base portion is coupled to the container; and
(c) a squeezing element coupled to the base portion and movable between a closed position in which the squeezing element squeezes the external fluid conduit shut to prevent the fluid from flowing therethrough and an opened position in which the squeezing element is positioned such that the fluid can flow through the external fluid conduit.

2. The dispenser as claimed in claim 1, wherein the squeezing element is slidable on the base portion between the opened and closed positions.

3. The dispenser as claimed in claim 2 further comprising:
a tension band wrapped around the base portion and the squeezing element to bias the squeezing element to the closed position.

4. The dispenser as claimed in claim 1, wherein the base further comprises a shoulder located adjacent one half of the external fluid conduit and the squeezing element comprises a projection located adjacent the other half of the external fluid conduit, and wherein the projection squeezes the external fluid conduit against the shoulder when the squeezing element is in the closed position.

5. The dispenser as claimed in claim 4, wherein the shoulder comprises a recess aligned with the projection and into which the external fluid conduit is pushed when the squeezing element is in the closed position.

6. The dispenser as claimed in claim 1, wherein the squeezing element comprises an exit path terminating at a dispenser opening located along an outer surface of the dispenser and the external fluid conduit extends along the exit path and terminates at the dispenser opening to allow the fluid to exit via the dispenser opening when the squeezing element is in the opened position.

7. A dispenser for a container, the dispenser comprising:
(a) a base portion couplable to the container, wherein the base portion comprises a port through which fluid exiting the container passes when the base portion is coupled to the container;
(b) an external flexible fluid conduit fluidly coupled to the port, wherein the external fluid conduit is located outside of the container when the base portion is coupled to the container; and
(c) at least two squeezing elements pivotally coupled to the base portion and movable between a closed position in which the squeezing elements collectively squeeze the external fluid conduit shut to prevent the fluid from flowing therethrough and an opened position in which the squeezing elements are positioned such that the fluid can flow through the external fluid conduit.

8. The dispenser as claimed in claim 7, wherein each of the squeezing elements comprises a fulcrum and a projection and wherein the base portion comprises a pair of ledges each supporting one of the fulcrums, the squeezing elements pivoting on the fulcrums as they transition between the closed and opened positions and the projections collectively squeezing the external fluid conduit when the squeezing elements are in the closed position.

9. The dispenser as claimed in claim 8 further comprising:
a tension band wrapped around the base portion and the squeezing elements to bias the squeezing elements to the closed position.

10. The dispenser as claimed in claim 8, wherein the fulcrums are located midway along the squeezing elements and the projections are located nearer to the container than the fulcrums.

11. The dispenser as claimed in claim 1, further comprising:
an internal fluid conduit fluidly coupled to the port and located inside the container when the base portion is coupled to the container.

12. The dispenser as claimed in claim 11, wherein the internal and external fluid conduits comprise different portions of a flexible tube.

13. The dispenser as claimed in claim 11 further comprising:
a sealing element positioned between the external fluid conduit and the perimeter of the port to create a fluidic seal between the external fluid conduit and the perimeter of the port.

14. The dispenser as claimed in claim 13, wherein the sealing element comprises:
(a) a hollow member inserted through the port through which the fluid exiting the container passes, wherein the hollow member has wrapped on one end portion the external fluid conduit and wrapped on another end portion the internal fluid conduit and wherein the external fluid conduit is sandwiched between the hollow member and the perimeter of the port; and
(b) a fluid conduit flange located on the hollow member between the hollow member and the external fluid conduit that helps retain the external fluid conduit on the hollow member.

15. The dispenser as claimed in claim 14 further comprising:
an internal flange located on a portion of the hollow member located within the container when the base portion is coupled to the container and sized to press against a surface around the port to prevent the sealing element from being pulled from the container.

16. The dispenser as claimed in claim 14 further comprising:
a conduit retaining unit coupled to the internal fluid conduit, wherein the conduit retaining unit comprises a plurality of arms each being sufficiently long to press against the interior of the container such that the conduit retaining unit is secured within the container when located therein.

17. The dispenser as claimed in claim 11 further comprising:
a flavour dispensing unit fluidly coupled to an end of the internal fluid conduit into which the fluid enters, the flavour dispensing unit comprising:
(a) a housing having an inlet into which the fluid is drawn and an outlet fluidly coupled to the end of the internal fluid conduit into which the fluid enters;
(b) a flavour block contained within the housing; and
(c) a fluid channel through which the fluid passes as it travels from the inlet to the outlet and fluidly coupled to the flavour block such that portions of the flavour block dissolve into the fluid as the fluid flows through the fluid channel.

18. [A] The dispenser as claimed in claim 1, wherein the base portion is threaded to allow the base portion to be directly screwed on to the container and over a mouth of the container, and wherein the base portion, except for the port, seals the mouth.

19. The dispenser as claimed in claim 1, wherein the base portion has a planar surface via which the base portion may be mounted on to a bottle cap.
